(19) United States
(12) Patent Application Publication
(10) Pub. No.: US 2025/0279963 A1
(43) Pub. Date: Sep. 4, 2025

(54) SYSTEMS AND METHODS FOR DSCP MARKING

(71) Applicant: VERIZON PATENT AND LICENSING INC., Basking Ridge, NJ (US)

(72) Inventors: Taral PATEL, Piscataway, NJ (US); John M. BITTENBENDER, Bloomsburg, PA (US)

(73) Assignee: VERIZON PATENT AND LICENSING INC., Basking Ridge, NJ (US)

(21) Appl. No.: 18/592,184

(22) Filed: Feb. 29, 2024

(51) Int. Cl. H04L 47/2425; H04L 69/16; H04L 69/22

(52) U.S. Cl. CPC H04L 47/2433; H04L 69/162; H04L 69/22

(57) ABSTRACT

Disclosed are systems and methods for a DSCP (Differentiated Services Code Point) marking framework. The disclosed framework provides mechanisms for managing how network requests are handled, on the client and/or server side (e.g., prior to transmission over the network, and/or upon transmission for handling by a server, for example). The disclosed framework provides functionality for dynamically determining and applying DSCP marking that enables networks, and associated network components, to maintain a consistent and reliable network experience by computationally managing how network traffic is managed and transmitted by and between network components.

### BACKGROUND INFORMATION

DSCP (Differentiated Services Code Point) marking is a way to classify and prioritize network traffic by assigning a specific value to packets. DSCP marking can be used to ensure that different types of traffic receive appropriate treatment as they traverse a network.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example network architecture according to some embodiments of the present disclosure;

FIG. 1B is a block diagram illustrating components of an exemplary system according to some embodiments of the present disclosure;

FIGS. 2A-2B depict non-limiting example network embodiments according to some embodiments of the present disclosure

FIGS. 3A-3B illustrate exemplary workflows according to some embodiments of the present disclosure;

FIG. 4 illustrates a non-limiting example embodiment of a network architecture according to some embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

DSCP marking plays an important role in managing and prioritizing network traffic to optimize performance and ensure quality of service (QOS) for wireless networks. When data is transmitted over a wireless network, the data is broken down into packets, each of which contains a header with various fields, including the DSCP field. The DSCP field assigns a specific value to the packet, indicating its priority or class of service. For example, DSCP marking involves setting a value in the IP header of a packet, specifically in the Differentiated Services (DS) field (also referred to as the Type of Service (ToS) field). This value, known as the DSCP value, is a 6-bit field that defines the class or priority of the packet.

In a wireless environment where bandwidth is often shared among multiple users and devices, DSCP marking allows network administrators to implement policies that prioritize certain types of traffic over others. For example, voice or video data, which require low latency and consistent throughput, can be assigned higher priority DSCP values compared to less time-sensitive traffic such as, for example, email or web browsing. Wireless network components, servers, access points and routers, for example, can use such DSCP values to prioritize the forwarding and delivery of packets, ensuring that critical applications receive preferential treatment and that network resources are efficiently utilized. Accordingly, proper DSCP marking can help maintain a consistent and reliable user experience, even in congested wireless environments, by ensuring that important traffic gets through without delays or interruptions.

Thus, according to some embodiments, as discussed herein, the disclosed framework provides mechanisms for managing how network requests are handled, on the client and/or server side (e.g., prior to transmission over the network, and/or upon transmission for handling by a server, for example). The disclosed framework provides functionality for dynamically determining and applying DSCP marking that enables networks, and associated network components, to maintain a consistent and reliable network experience by computationally managing how network traffic is managed and transmitted by and between network components.

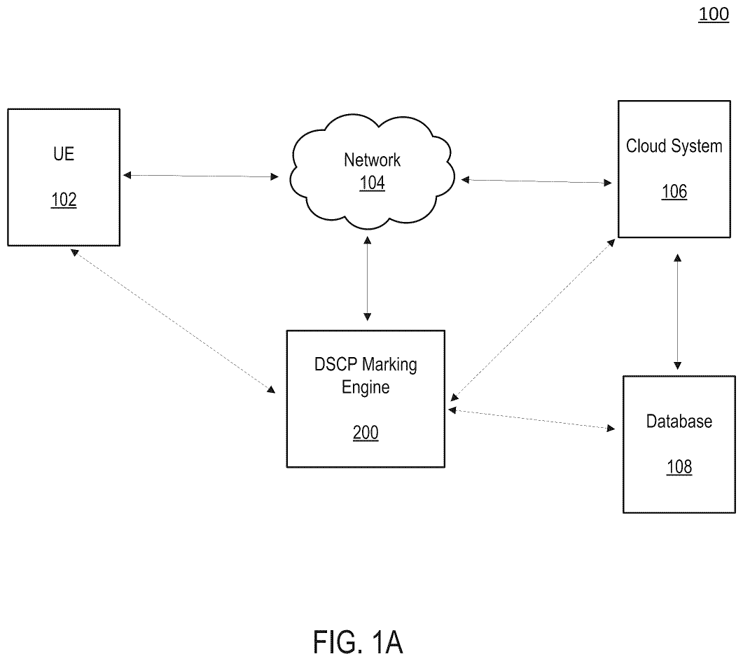

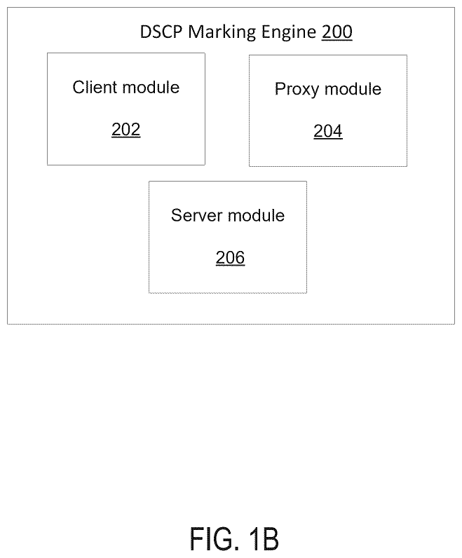

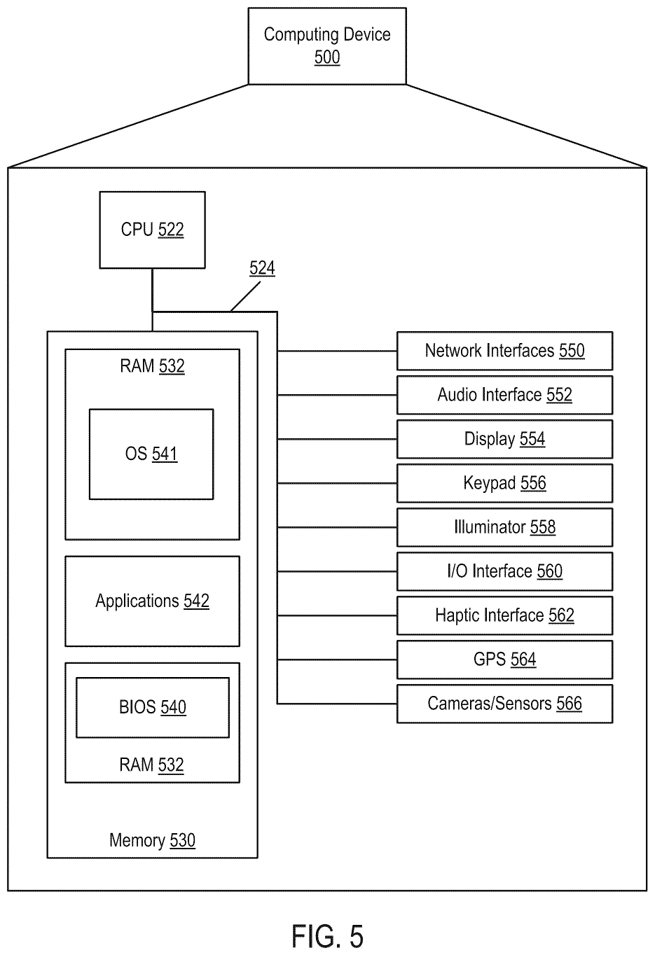

With reference to FIG. 1A, system 100 is depicted which includes user equipment (UE) 102 (e.g., a client device, as mentioned above and discussed below in relation to FIG. 5), network 104, cloud system 106, database 108, and DSCP marking engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1A.

According to some embodiments, UE 102 can be any type of network device, as discussed above. For example, UE 102 can include, but not be limited to, a mobile phone, tablet, laptop, game console, smart television (TV), Internet of Things (IoT) device, wearable device, an autonomous vehicle (AV), autonomous machine, unmanned aerial vehicle (UAV), and/or any other device equipped with a cellular or wireless or wired transceiver.

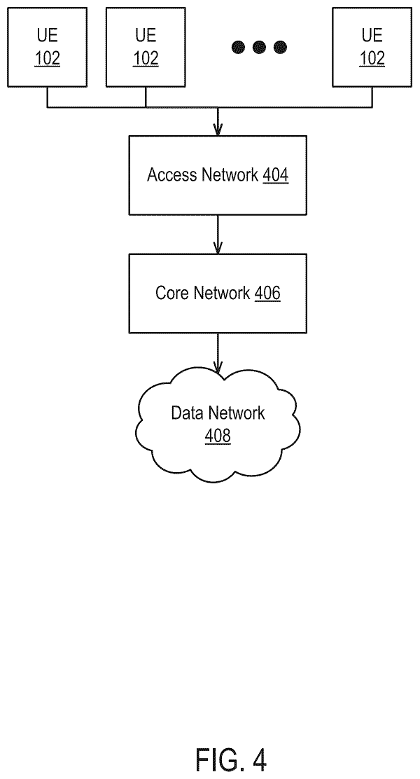

In some embodiments, network 104 can be any type of network, such as, but not limited to, a wireless network, cellular network, the Internet, and the like (as discussed above). Network 104 facilitates connectivity of the components of system 100, as illustrated in FIG. 1A. Further discussion of embodiments of network 104 are provided below with reference to FIG. 4.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a cellular provider, which has associated network resources hosted on the internet or private network (e.g., network 104), which enables (via engine 200) the DSCP marking operations discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102 and the services and applications provided by cloud system 106 and/or engine 200).

In some embodiments, for example, cloud system 106 can provide a private/proprietary management platform, whereby DSCP marking engine 200, discussed infra, corresponds to the novel functionality system 106 enables, hosts and provides to a network 104 and other devices/platforms operating thereon.

According to some embodiments, database 108 may correspond to a data storage for a platform (e.g., a network hosted platform, such as cloud system 106, as discussed supra) or a plurality of platforms. Database 108 may receive storage instructions/requests from, for example, DSCP marking engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

DSCP marking engine 200, as discussed above and further below in more detail, can include components for the disclosed functionality. According to some embodiments, DSCP marking engine 200 may be a special purpose machine or processor, and can be hosted by a device (or component) on network 104, within cloud system 106 and/or on UE 102. In some embodiments, DSCP marking engine 200 may be hosted by a server and/or set of servers associated with cloud system 106.

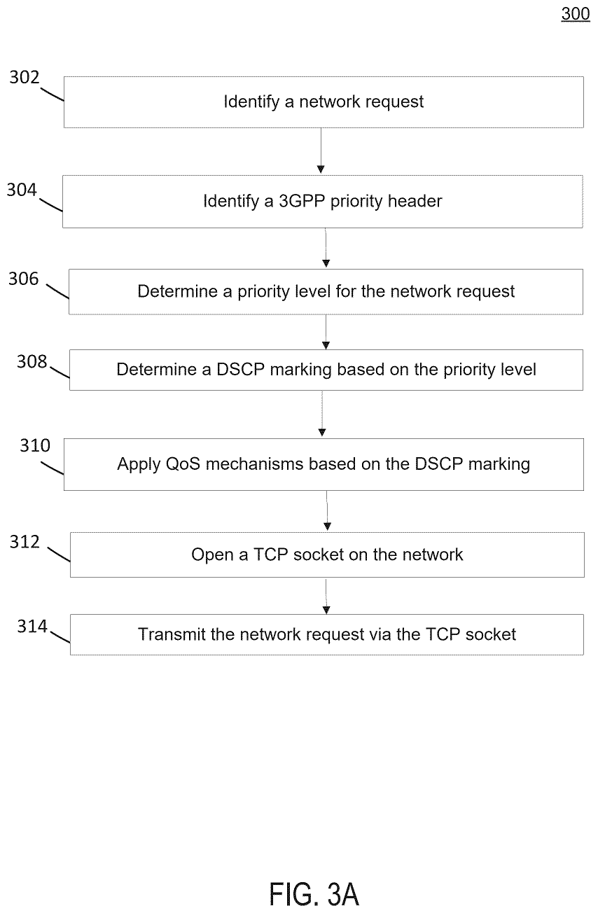

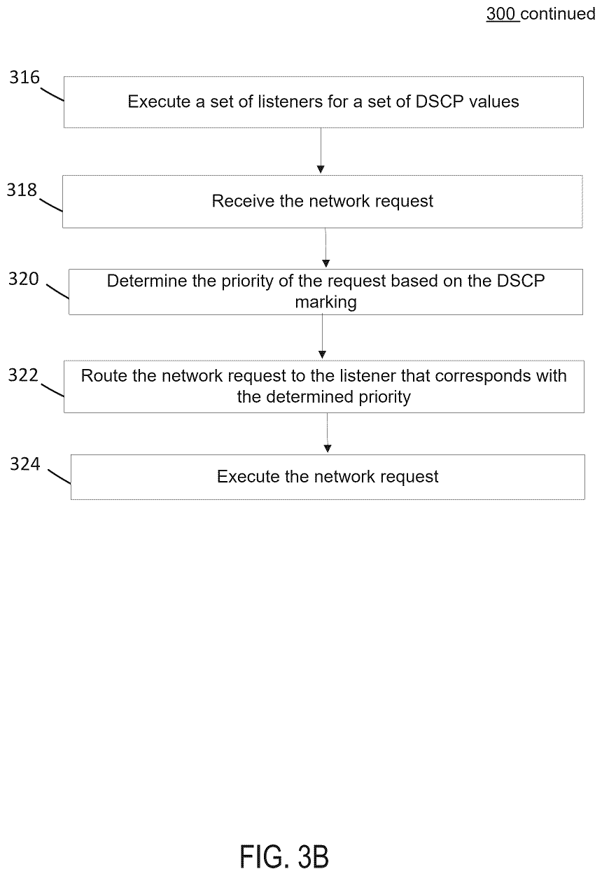

According to some embodiments DSCP marking engine 200 may be configured to implement and/or control a plurality of services and/or microservices, where each of the plurality of services/microservices are configured to execute a plurality of workflows associated with performing the disclosed connection management. Non-limiting embodiments of such workflows are provided below in relation to at least FIGS. 3A-3B.

According to some embodiments, DSCP marking engine 200 may function as an application provided by and/or hosted by cloud system 106. In some embodiments, DSCP marking engine 200 may function as an application installed on a server(s), network location and/or other type of network resource associated with system 106. In some embodiments, DSCP marking engine 200 may function as an application installed and/or executing on UE 102. In some embodiments, such application may be a web-based application accessed by UE 102. In some embodiments, DSCP marking engine 200 may be configured and/or installed as an augmenting script, program or application (e.g., a plug-in or extension) to another application or program provided by cloud system 106 and/or executing on UE 102.

As illustrated in FIG. 1B, according to some embodiments, DSCP marking engine 200 includes client module 202, proxy module 204 and server module 206. It should be understood that the connection broker(s) and modules discussed herein are non-exhaustive, as additional or fewer brokers and/or modules (or sub-modules) may be applicable to the embodiments of the systems and methods discussed. More detail of the operations, configurations and functionalities of DSCP marking engine 200 and each of its modules, and their role within embodiments of the present disclosure will be discussed below.

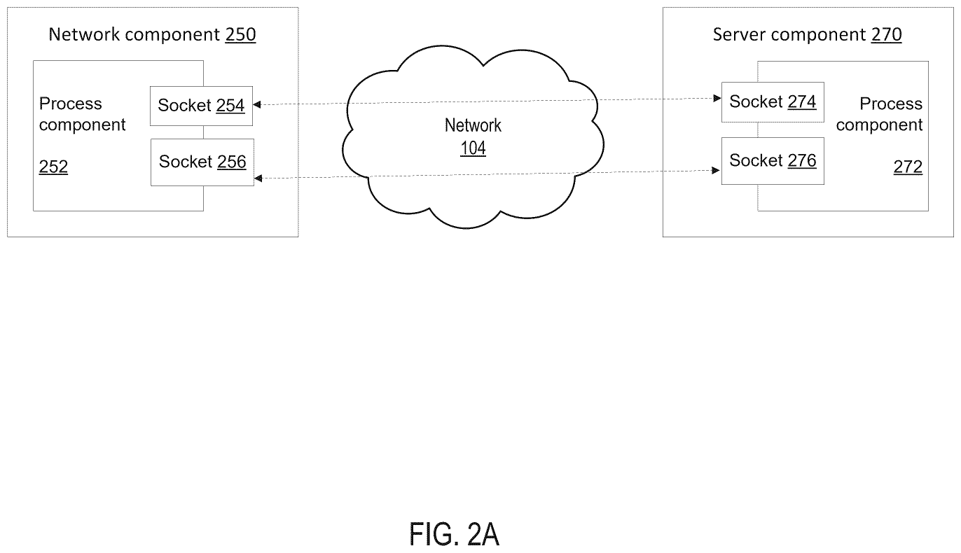

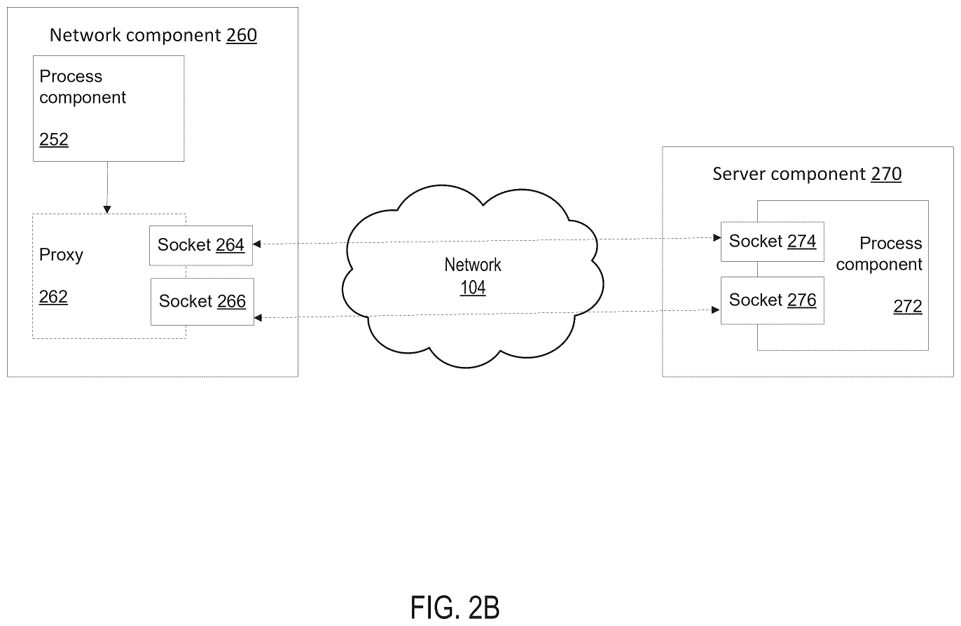

FIGS. 2A and 2B depict non-limiting example embodiments for how the disclosed DSCP marking functionality can be provided and/or implemented over a network. For example, as discussed below, FIG. 2A provides example embodiments for a physical network function (PNF) and/or virtual network function (VNF) processing a network request; whereas, FIG. 2B depicts an example of a PNF/VNF leveraging a proxy to process the network request.

In FIG. 2A, depicted are network component 250, network 104 and server component 270. Network component 250 can be a PNF, for example, a cloud-native network function (CNF) or similar container on network 104 (e.g., discussed in more detail below respective to FIG. 4). As depicted, component 250 can include, but is not limited to, process component 252 and sockets 254 and 256.

In some embodiments, process component 252 can be any type of software, application program interface (API) and the like, that provides the functionality for the network component 250. For example, component 252 can be a microservice application and/or containerized application that provides functionality for a CNF (e.g., component 250) to perform cloud-native environment capabilities.

As discussed with reference to FIG. 3A, functionality related to client module 202's execution can correspond to the execution of process component 252 (and component 262, discussed with reference to FIG. 2B, discussed infra).

In some embodiments, sockets 254 and 256 can be transmission control protocol (TCP) sockets which can provide bidirectional communication via the network 104. According to some embodiments, as discussed in more detail below, sockets 254 and 256 can provide functionality for the disclosed DSCP marking via application-level configuration, QoS and/or network device configuration. That is, applications utilizing TCP sockets can configure the DSCP value for outgoing packets through the use of socket options and/or API calls provided by the operating system. For example, applications may set the DSCP value using socket options like “IP_TOS” or “IPV6_TCLASS” before initiating data transmission. Further, requests and/or packets can be subject to QoS determinations, discussed infra, such that they can be prioritized and/or treated differently based on their DSCP values, ensuring that high-priority traffic receives preferential treatment within the network. Moreover, DSCP markings of incoming packets can be examined, whereby corresponding DSCP values can enable classification, prioritization, and management of traffic flows according to configured QoS policies.

Server component 270 represents the server components and/or devices operating on the network that handle the network requests. In some embodiments, component 270 can be, but is not limited to, a VNF, CNF, PNF, edge network function (ENF), management and orchestration (MANO) component, and the like. Thus, component 270 can be and/or include network functions (xNFs) that can be virtualized, containerized and/or deployed on special hardware to provide network capabilities within the infrastructures of network 104.

Server component 270 can include, but is not limited to, process component 272 and sockets 274-276. Process component 272 should be understood to be counterpart to and operate in a similar manner as process component 252. Sockets 274-276 can correspond to listeners that are executed by component 272, such that the particular socket among sockets 274-276 depends on the priority as indicated by the DSCP marking of an incoming request, as discussed infra.

As discussed with reference to FIG. 3B, functionality related to server module 206′s execution can correspond to the execution of process component 272.

In FIG. 2B, depicted are embodiments where a proxy can be implemented on the “client” (or transmission) side of the network environment. Network components 260 and sockets 264-266 operate in a similar manner as discussed above respective to component 250 and sockets 254-256, respectively.

In some embodiments (e.g., as depicted via the dashed lines of the proxy 262 item), proxy 262 can be directly associated with (e.g., connected and/or executed by) network component 260. For example, such embodiment can exist when component 260 is a PNF. In some embodiments, when component 260 is a VNF, proxy 262 can be an external component to component 260. Thus, for example, proxy 260 can be a PNF proxy (for physical functions, for example) or a VNF proxy (for virtualized instances, for example).

As discussed with reference to FIG. 3A, functionality related to proxy module 204's execution can correspond to the execution of proxy 262.

The implementation and functionality of the components within FIGS. 2A and 2B will be discussed further with reference to the executed steps of Process 300 in FIGS. 3A and 3B.

In FIGS. 3A-3B, Process 300 provides non-limiting example embodiments for implementing the disclosed DSCP marking. As provided below, FIG. 3A provides the steps that are performed on the “client” side, and the steps in FIG. 3B provide steps that are performed on the “server” side. Effectively, Process 300 provides embodiments for a network request that can be assigned, prioritized markings that impact how it is sent over the network, and received upon its reception.

According to some embodiments with respect to FIGS. 3A-3B, Steps 302-314 of Process 300 can be performed by client module 202 of DSCP marking engine 200; and Steps 316-324 can be performed by server module 206. In some embodiments, Steps 304-314 can be performed by proxy module 204, as discussed above.

According to some embodiments, Process 300 begins with Step 302 where a network request is identified. The network request can be related to, but not limited to, content, applications, portals, webpages, devices, databases, and the like. As discussed above in relation to at least FIGS. 1A and 2A-2B, the request can originate from and/or be related to a UE, network function, and the like. For example, such request can correspond to, but is not limited to, Hypertext Transfer Protocol (HTTP) requests, remote procedure calls (RPCs), database queries, file transfer requests (e.g., filed transfer protocol (FTP), SSH file transfer protocol (SFTP), secure copy protocol (SCP), and the like), domain name system (DNS) queries, simple mail transfer protocol (SMTP) requests, WebSocket requests, Simple Object Access Protocol (SOAP requests, and the like.

In Step 304, engine 200 can analyze the network request, and identify a 3GPP priority header. The header can include information related to, but not limited to, a destination, application or functionality, and the like, as discussed below. In some embodiments, engine 200 can parse the request and identify the header.

By way of background, 3GPP (third generation partnership project) is a collaboration between groups of telecommunications standards associations, known for developing standards for mobile telecommunications, including 3G, 4G, and 5G networks. A 3GPP priority header refers to a field within the header of a network request (e.g., packet or message, as in Step 302) that indicates the priority level assigned to that request.

According to some embodiments, as discussed above, a priority header can be used to prioritize the handling of requests within a network. The header allows network operators to give preferential treatment to certain types of traffic based on their importance or characteristics. For example, real-time communication applications like voice and video calls may be assigned a higher priority to ensure low latency and smooth transmission, while non-real-time data like emails or file downloads may be assigned a lower priority.

Accordingly, in Step 306, engine 200 can analyze the information indicated within the 3GPP header and determine the priority level of the network request. Thus, as discussed above with reference to FIGS. 2A and 2B, upon determination of the priority level of the message, a network socket (e.g., TCP socket) can be created that has associated therewith particular DSCP markings that align with the priority of the message. Thus, in Step 308, engine 200 can apply a DSCP marking to the request, which can trigger how the request is handled and/or prioritized upon its transmission to the server, discussed infra. In some embodiments, such DSCP marking can be inserted into the 3GPP header of the request, thus modifying the request to include the generated marking.

By way of a non-limiting example, as depicted in FIG. 2A, the network request can be received (or provided) by process component 252, whereby socket 254 or 256 can be created (or applied or opened) to the request based on the determined priority. For example, if the request has a high priority, socket 254 can be applied, such that the request is filtered through that socket on its way over network 104 to server component 270, whereby a “high priority” DSCP marking can thereby be applied prior to its network transmission. Similar can be performed for low priority requests via socket 256, for example.

As discussed above, the processing by engine 200 can be performed via proxy module 204. Thus, turning to FIG. 2B, rather than process component 252 facilitating the socket generation and/or implementation, the request can be provided to proxy 262, whereby proxy 262 can perform similar socket and DSCP marking implementation as discussed above.

In Step 310, engine 200 can apply QoS mechanisms to the request based on the applied DSCP marking. That is, according to some embodiments, DSCP marking can be used to indicate the priority or class of service for a request (e.g., packet), allowing routers and other network devices to apply appropriate QoS policies, as discussed infra.

According to some embodiments, QoS policies correspond to or are based on a variety of different factors or mechanisms. For example, service level agreements (SLAs) can specify the QoS requirements for different types of traffic. These SLAs may include parameters such as latency, jitter, packet loss and the like. Based on these SLAs, network operators/functions can decide on the priority levels for different types of traffic.

In another example, traffic classification mechanisms can be employed to identify different types of traffic flows within the network. For example, real-time traffic like voice and video calls might be classified as high-priority traffic, while bulk data transfers might be classified as low-priority traffic.

In another example, QOS can employ policy-based routing, in that once traffic is classified, policies can be applied to determine the appropriate treatment for each traffic class. In some embodiments, this can involve assigning specific DSCP values to each traffic class based on their priority level.

In yet another non-limiting example, once packets are marked with the appropriate DSCP values, traffic management mechanisms within the network (e.g., network 104 as in FIGS. 1A and 2A-2B) can use such DSCP markings to enforce QoS policies such as traffic shaping, prioritization, queuing, and the like.

Thus, as discussed herein, the determination of DSCP marking for priority level in a 3GPP network can involve a combination of traffic classification, policy-based routing, DSCP mapping, and traffic management techniques to ensure that different types of traffic receive the appropriate level of service based on the network operator's requirements.

In Step 312, engine 200 can open the TCP socket, which in some embodiments, corresponds to the socket utilized to determine the DSCP marking, discussed supra. In Step 314, such socket can be used to transmit the network request the destination, as discussed above and depicted in FIGS. 2A-2B.

Turning to FIG. 3B, continuing with Process 300, engine 200 can cause the execution of a set of listeners for a set of DSCP values. For example, with reference to FIG. 2A, if network component 250 has two sockets 254 and 256, each with their own DSCP value, then server component 270 can configure two sockets 274 and 276 to listen for messages for such DSCP values. According to some embodiments, each listener can have their own queue, so that messages with particular priority values can be prioritized according to their categorized class.

According to some embodiments, a listener (as discussed herein, in the context of a server network function(s)), refers to a component or mechanism that listens for incoming messages or packets on a specific network interface or port. The listener can be responsible for receiving and processing requests, which can be in accordance with the prioritization assigned to them. According to some embodiments, there are various ways a listener can be implemented to receive prioritized messages or packets.

For example, with reference to FIGS. 2A-2B, server component 270 can create a socket listener that binds to a specific network interface and port (e.g., socket 274-276). Such listener can be configured to accept incoming connections and receive data packets. The server can then implement logic to prioritize incoming packets based on their characteristics, such as the source, destination, or type of data.

In another example, server component 270 can use a message queue system, such as, but not limited to, RabbitMQ®, Apache Kafka®, AWS SQS®, and the like, as a listener. Such systems allow messages to be published to specific queues with different priorities. The server component 270 can consume messages from these queues and process them accordingly, giving priority to higher-priority messages.

In another example, server component 270 can implement an event-driven architecture where different events trigger corresponding event handlers. Incoming messages or packets can be treated as events, and the server can prioritize processing based on the type or properties of these events.

In another example, server component 270 can use a custom protocol or messaging format that includes prioritization information in the message headers. The listener can be implemented to parse these headers and prioritize messages accordingly.

In yet another example, server component 270 can leverage network devices that support QoS mechanisms that allow for the prioritization of network traffic based on criteria such as DSCP markings (and/or virtual local area network (VLAN) tags, for when VMs are applied for example). The listener can be configured to receive packets with specific priority markings and process them accordingly.

Thus, a listener includes capabilities to receive incoming messages or packets and handle them in a prioritized manner, which ensures that critical or time-sensitive tasks are handled promptly and efficiently.

Thus, in Step 318, the network request (transmitted from Step 314) can be received by the destination network component (e.g., server, for example). In Step 320, engine 200 can analyze the 3GPP header of the request, and identify the DSCP marking of the request. Then, in Step 322, the request can be routed to the appropriate listener (and related socket) that corresponds to the priority. Step 322 can involve opening the appropriate socket for such priority/listener. For example, as discussed above, a request from socket 264 can be received via socket 274, as they correspond to the same (or similar, within a threshold or class of priority) DSCP priority/value.

In Step 324, engine 200 can execute the request. For example, if a network resource is requested, such resource can be retrieved, according to its priority in relation to other received requests and their respective priority. Then, in some embodiments, such resource can be transmitted back to the requesting network entity, whereby the response message/packet can include the same DSCP marking of the request that triggered the response message.

For example, server component 270 can determine a response via process 272, then transmit the response, with DSCP marking within the 3GPP header of the response message, to socket 264 of network component 260, as depicted in FIG. 2B.

Thus, Process 300 provides mechanisms that enable messages to be transmitted to, from and/or among network components that enables them to be prioritized, while establishing a same destination endpoint via sockets that enable the transmission and reception of such messages via determined DSCP values of the messages.

FIG. 4 is a block diagram of an example network architecture according to some embodiments of the present disclosure. In the illustrated embodiment, UE 102 accesses a data network 408 via an access network 404 and a core network 406.

In the illustrated embodiment, the access network 404 comprises a network allowing network communication with UE 102. In general, the access network 404 includes at least one base station that is communicatively coupled to the core network 406 and coupled to zero or more UE 102.

In some embodiments, the access network 404 comprises a cellular access network, for example, a 5G network. In an embodiment, the access network 404 can include a NextGen Radio Access Network (NG-RAN). In an embodiment, the access network 404 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 404 provides access to a core network 406 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 406 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 406 and to external network-attached elements in a data network 408 such as the Internet.

In the illustrated embodiment, the access network 404 and the core network 406 are operated by a NO. However, in some embodiments, the networks (404, 406) may be operated by a private entity and may be closed to public traffic. For example, the components of the network 406 may be provided as a single device, and the access network 404 may comprise a small form-factor base station. In these embodiments, the operator of the device can simulate a cellular network, and UE 102 can connect to this network similar to connecting to a national or regional network.

In some embodiments, the access network 404, core network 406 and data network 408 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a CPU 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
identifying a header of a network request, the header comprising priority information for the network request;
determining, based on the priority information, a Differentiated Services Code Point (DSCP) marking;
opening, on a network, a transmission control protocol (TCP) socket, the opened TCP socket being related to a value of the DSCP marking; and
communicating, via the opened TCP socket, the network request to a destination identified within the header.

2. The method of claim 1, further comprising:
receiving a response message, the response message comprising a DSCP marking with the value of the DSCP marking associated with the network request.

3. The method of claim 1, wherein determining the DSCP marking is performed by a network function on the network.

4. The method of claim 3, wherein opening the TCP socket is performed by the network function.

5. The method of claim 3, wherein opening the TCP socket is performed by a proxy associated with the network function.

6. The method of claim 1, wherein the destination corresponds to a server on the network, wherein the server receives the communicated network request via a socket that corresponds to the value of the DSCP marking.

7. The method of claim 1, wherein the network request is modified via insertion of the DSCP marking into the header.

8. The method of claim 1, further comprising:
determining a Quality of Service (QOS) mechanism for the network request based on the DSCP marking; and
applying the QoS mechanism to the network request, wherein the communicated network request is subject to the applied QoS mechanism.

9. A network device comprising:
a processor configured to:
identify a header of a network request, the header comprising priority information for the network request;
determine, based on the priority information, a Differentiated Services Code Point (DSCP) marking;
open, on a network, a transmission control protocol (TCP) socket, the opened TCP socket being related to a value of the DSCP marking; and
communicate, via the opened TCP socket, the network request to a destination identified within the header.

10. The network device of claim 9, wherein the processor is further configured to:
receive a response message, the response message comprising a DSCP marking with the value of the DSCP marking associated with the network request.

11. The network device of claim 9, wherein the determination of the DSCP marking is performed by a network function of the network device on the network.

12. The network device of claim 11, wherein the opening of the TCP socket is performed via the network function.

13. The network device of claim 11, wherein the opening of the TCP socket is performed via a proxy associated with the network device.

14. The network device of claim 9, wherein the destination corresponds to a server on the network, wherein the server receives the communicated network request via a socket that corresponds to the value of the DSCP marking.

15. The network device of claim 9, wherein the network request is modified via insertion of the DSCP marking into the header.

16. The network device of claim 9, wherein the processor is further configured to:
determine a Quality of Service (QOS) mechanism for the network request based on the DSCP marking; and
apply the QoS mechanism to the network request, wherein the communicated network request is subject to the applied QoS mechanism.

17. A non-transitory computer-readable storage medium tangibly encoded with computer-executable instructions, that when executed by a network device, perform a method comprising:
identifying a header of a network request, the header comprising priority information for the network request;
determining, based on the priority information, a Differentiated Services Code Point (DSCP) marking;
opening, on a network, a transmission control protocol (TCP) socket, the opened TCP socket being related to a value of the DSCP marking; and
communicating, via the opened TCP socket, the network request to a destination identified within the header.

18. The non-transitory computer-readable storage medium of claim 17, further comprising:
receiving a response message, the response message comprising a DSCP marking with the value of the DSCP marking associated with the network request.

19. The non-transitory computer-readable storage medium of claim 17, wherein the destination corresponds to a server on the network, wherein the server receives the communicated network request via a socket that corresponds to the value of the DSCP marking.

20. The non-transitory computer-readable storage medium of claim 17, further comprising:
determining a Quality of Service (QOS) mechanism for the network request based on the DSCP marking; and
applying the QoS mechanism to the network request, wherein the communicated network request is subject to the applied QoS mechanism.
